(19) United States
(12) Patent Application Publication
(10) Pub. No.: US 2008/0296397 A1
(43) Pub. Date: Dec. 4, 2008

(54) AUTOMATIC HEATING UNIT FOR PERSONAL COMPUTER

(76) Inventor: Ta-Yang Cheng, Taipei (TW)

Correspondence Address: Dykema Gossett, PLLC, Suite 300 West, 1300 I Streee, N.W., Washington, DC, 20005-3306, US

(21) Appl. No.: 11/755,075

(22) Filed: May 30, 2007

(51) Int. Cl. H05B 1/02

(52) U.S. Cl. 237/2 R

(57) ABSTRACT

An automatic heating unit for personal computer includes an instruction save circuit that receives a turn-on signal from a power switch of the personal computer (PC) to thereby drive a temperature sensing circuit to sense an ambient temperature inside the PC. When it senses the ambient temperature is too low to allow normal computer booting, the temperature sensing circuit outputs a heating signal to drive a heating circuit to heat an interior of the PC. Otherwise, the temperature sensing circuit outputs a booting signal to enable a booting circuit to supply power to a mainboard of the PC.

### FIELD OF THE INVENTION

The present invention relates to an automatic heating unit for personal computer, and more particularly to a heating unit that automatically heats an ambient temperature inside a personal computer to a normal temperature before the personal computer turned on at an extremely low temperature is automatically booted.

### BACKGROUND OF THE INVENTION

Most commercially available computers have a normal operating temperature within the range from 0° C. to 45° C. However, there are some countries having an indoor temperature as low as from −20° C. to −30° C. in winter. Some oil or water containing components in the computer, such as the hard disk, the electrolytic capacitor, the fan, the CDROM, etc., tend to become frozen under the extremely low temperature, preventing the computer booted at the low temperature from operating normally.

A common measure to overcome the problem of frozen oil/water containing computer components is to raise the indoor temperature so as to increase an ambient temperature inside the computer at the same time. However, it is obviously not economical to heating a whole big room just to create an environment suitable for booting the computer. Moreover, since it takes a relatively long time to reach the desired booting temperature, the above-mentioned heating measure is quite inefficient to meet modern people's requirement for efficiency.

It is therefore tried by the inventor to overcome the confusion of booting computer at low temperature by developing an automatic heating unit for PC.

### SUMMARY OF THE INVENTION

A primary object of the present invention is to provide an automatic heating unit for personal computer (PC) so that a PC turned on at an extremely low temperature is internally automatically heated by the heating unit to a proper operating temperature before the computer is automatically booted. In this manner, the computer performance and internal components are effectively protected.

To achieve the above and other objects, the automatic heating unit for PC according to the present invention includes an instruction save circuit capable of receiving a turn-on signal from a power switch of the PC; a temperature sensing circuit driven by the instruction save circuit having received the PC turned-on signal to sense an ambient temperature inside the PC, and the temperature sensing circuit outputting a heating signal when the sensed ambient temperature is too low to allow normal computer booting, or a booting signal when the sensed ambient temperature is normal for computer booting; a heating circuit capable of receiving the heating signal from the temperature sensing circuit to thereby start heating; and a booting circuit capable of receiving the booting signal from the temperature sensing circuit to thereby allow power supply to a mainboard of the PC.

### BRIEF DESCRIPTION OF THE DRAWINGS

The structure and the technical means adopted by the present invention to achieve the above and other objects can be best understood by referring to the following detailed description of the preferred embodiment and the accompanying drawing, wherein
FIG. 1 is a circuit diagram of an automatic heating unit for personal computer according to an operable embodiment of the present invention.

### DETAILED DESCRIPTION OF THE PREFERRED EMBODIMENTS

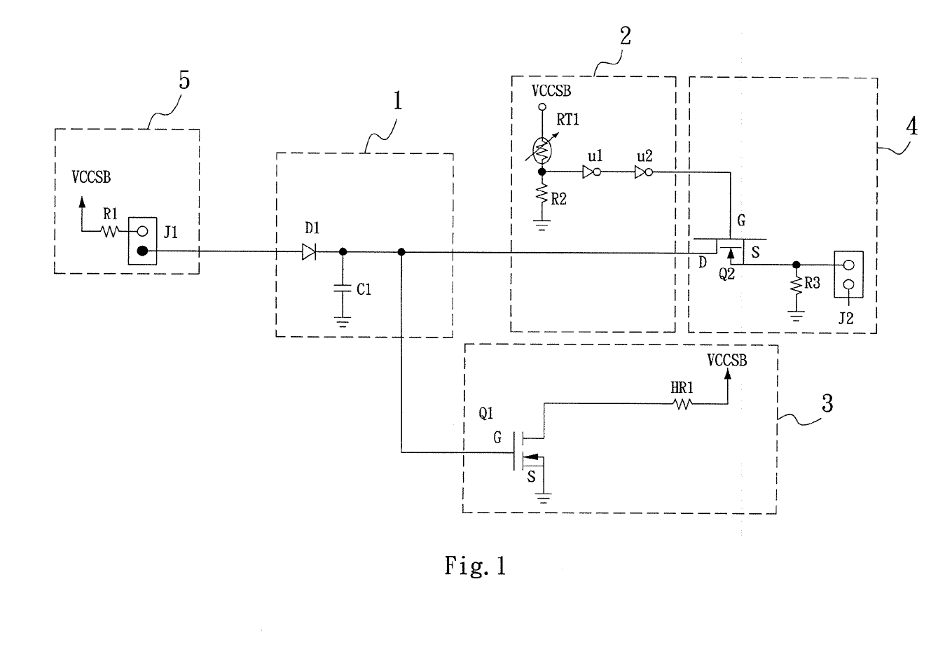

Please refer to FIG. 1 that is a circuit diagram of an automatic heating unit for personal computer (PC) according to an operable embodiment of the present invention. As shown, the automatic heating unit for PC according to the present invention includes an instruction save circuit 1, a temperature sensing circuit 2, a heating circuit 3, and a booting circuit 4.

The instruction save circuit 1 receives a turn-on signal from a power switch 5 of a computer, and drives the temperature sensing circuit 2 to work. The temperature sensing circuit 2 driven by the instruction save circuit 1 is able to sense an ambient temperature inside the computer. The temperature sensing circuit 2 outputs a heating signal when the ambient temperature inside the computer is too low to allow normal computer booting; and a booting signal when the ambient temperature inside the computer is normal for booting. The heating circuit 3 receives the heating signal from the temperature sensing circuit 2 and is excited to start heating.

The booting circuit 4 receives the booting signal from the temperature sensing circuit 2 and enables power supply to a mainboard of the computer.

In the above-described circuit structure, the instruction save circuit 1 consists of a diode D1 and a capacitor C1; the temperature sensing circuit 2 consists of a temperature sensing resistor RT1, a resistor R2, and two inverters U1, U2; the heating circuit 3 consists of a heater HR1, which may be arranged on the mainboard or in a case of the computer, and a field effect transistor (FET) Q1; and the booting circuit 4 consists of a resistor R3 and an FET Q2.

When the computer power switch 5 is turned on to electrically connect to a power supply VCCSB, the capacitor C1 of the instruction save circuit 1 is directly charged to have an increased potential HI. At this point, the temperature sensing resistor RT1 of the temperature sensing circuit 2 senses the ambient temperature inside the computer. When the ambient temperature is too low, a divided voltage between the temperature sensing resistor RT1 and the resistor R2 is relatively low and the FET Q2 of the booting circuit 4 is not ON. At this point, the FET Q1 of the heating circuit 3 is ON due to the high potential HI of the capacitor C1, bringing the heater HR1 to become ON and start heating, until the ambient temperature inside the computer is raised and the divide voltage between the temperature sensing resistor RT1 and the resistor R2 is high enough for the FET Q2 to become ON. At this point, a switch J2 of the booting circuit 4 is ON to supply power from the power supply VCCSB to the mainboard for the computer to boot and operate normally.

With the above arrangements, the automatic heating unit for PC according to the present invention allows a computer turned on at an extremely low ambient temperature to be automatically heated to a normal temperature before being automatically electrically connected for operation.

What is claimed is:

1. An automatic heating unit for PC, comprising:
an instruction save circuit capable of receiving a turn-on signal from a power switch of a PC;
a temperature sensing circuit driven by the instruction save circuit having received the signal of turned-on PC power switch to sense an ambient temperature inside the PC; and the temperature sensing circuit outputting a heating signal when the sensed ambient temperature is too low to allow normal computer booting, or a booting signal when the sensed ambient temperature is normal for computer booting;
a heating circuit capable of receiving the heating signal from the temperature sensing circuit to thereby become ON to start heating; and
a booting circuit capable of receiving the booting signal from the temperature sensing circuit to thereby allow power to be supplied to a mainboard of the PC.

2. The automatic heating unit for PC as claimed in claim 1, wherein the instruction save circuit consists of a diode and a capacitor.

3. The automatic heating unit for PC as claimed in claim 1, wherein the temperature sensing circuit consists of a temperature sensing resistor, a resistor, and two inverters.

4. The automatic heating unit for PC as claimed in claim 1, wherein the heating circuit consists of a heater and a field effect transistor.

5. The automatic heating unit for PC as claimed in claim 4, wherein the heater is arranged on the mainboard of the PC.

6. The automatic heating unit for PC as claimed in claim 4, wherein the heater is arranged in a case of the PC.

7. The automatic heating unit for PC as claimed in claim 1, wherein the booting circuit consists of a resistor and a field effect transistor.
